(19) United States
(12) Patent Application Publication
(10) Pub. No.: US 2026/0196175 A1
(43) Pub. Date: Jul. 9, 2026

(54) ELECTRONIC DEVICE

(71) Applicant: Samsung Display Co., LTD., Yongin-si (KR)

(72) Inventors: Ki Hyun PYUN, Yongin-si (KR); Jung Eon AN, Yongin-si (KR)

(21) Appl. No.: 19/419,611

(22) Filed: Dec. 15, 2025

(30) Foreign Application Priority Data
Jan. 3, 2025 (KR) 10-2025-0000579

(51) Int. Cl. G09G 3/3233

(52) U.S. Cl. CPC G09G 3/3233; G09G 2310/08; G09G 2330/025

(57) ABSTRACT

An electronic device includes a processor providing input image data to a display device; and the display device displaying an image based on the input image data. The display device includes a display panel including pixels connected to first and second power lines; a power generator supplying first driving power to the first power line and second driving power to the second power line; and a timing controller generating first to fourth enable signals for controlling the second driving power according to a driving mode. The second driving power includes (2_1)-th driving power having a positive value and (2_2)-th driving power having a negative value, and the power generator includes a second switch unit outputting the (2_2)-th driving power to the second power line in a first mode; and a first switch unit outputting the (2_1)-th driving power to the second power line in a second mode.

This application claims priority to Korean Patent Application No. 10-2025-0000579, filed on January 3, 2025, and all the benefits accruing therefrom under 35 U.S.C. §119, the content of which in its entirety is herein incorporated by reference.

### BACKGROUND

### (a) Technical Field

Various embodiments of the present disclosure relate to an electronic device.

### (b) Description of Related Art

As information technology has developed, importance of a display device, which is a connection medium between a user and information, has been highlighted. Accordingly, the use of display devices such as a liquid crystal display device, an organic light emitting display device, and the like has been increasing.

The display device includes pixels. The pixels may display a predetermined image by emitting light of predetermined luminance in response to a driving current flowing from first driving power to second driving power via a light emitting device.

The foregoing descriptions are only intended to facilitate understanding of the background art of the technical spirits of the present disclosure, and therefore, it cannot be understood as corresponding to the prior art known to those skilled in the art.

### SUMMARY

An electronic device according to embodiments of the present disclosure may have a plurality of driving modes and is aimed at preventing or mitigating a risk of electrical damage to the electronic device (or a circuit inside the electronic device) by controlling a value of second driving power according to the driving modes.

An electronic device according to embodiments of the present disclosure includes a processor for providing input image data to a display device; and the display device for displaying an image based on the input image data. The display device includes a display panel including pixels connected to a first power line, a second power line, scan lines, and data lines; a power generator for supplying first driving power to the first power line and second driving power to the second power line; and a timing controller for generating first to fourth enable signals for controlling the second driving power according to a driving mode. The second driving power includes (2_1)-th driving power having a positive value and (2_2)-th driving power having a negative value, and the power generator includes a first switch unit for outputting the (2_2)-th driving power to the second power line in a first mode; and a second switch unit for outputting the (2_1)-th driving power to the second power line in a second mode different from the first mode.

The power generator may further include a first output portion for outputting the (2_1)-th driving power based on the third enable signal; and a second output portion for outputting the (2_2)-th driving power based on the first enable signal.

The first switch unit may include a first switch for receiving the (2_1)-th driving power from the first output portion; and a first switch controller for turning off the first switch in the first mode and turning on the first switch in the second mode, in response to the fourth enable signal.

The second switch unit may include a second switch for receiving the (2_2)-th driving power from the second output portion; and a second switch controller for turning on the second switch in the first mode and turning off the second switch in the second mode, in response to the second enable signal.

The first switch controller may include a (1_1)-th switch transistor having a first electrode connected to ground, a second electrode connected to a second switch node, and a gate electrode connected to a first switch node; a second capacitor having a first electrode connected to the ground and a second electrode connected to the first switch node; and a second resistor with one end connected to the first switch node and another end supplied with the fourth enable signal.

The first switch may include a (1_2)-th switch transistor having a first electrode connected to a third switch node, a second electrode connected to a fourth switch node, and a gate electrode connected to the second switch node; a third capacitor having a first electrode connected to the second switch node and a second electrode connected to the third switch node; and a third resistor with one end connected to the second switch node and another end connected to the third switch node.

The (1_1)-th switch transistor may be an N-type transistor and the (1_2)-th switch transistor may be a P-type transistor.

The first switch may further include a fourth capacitor having a first electrode connected to the second switch node and a second electrode connected to the third switch node.

The second switch controller may include a (2_1)-th switch transistor having a first electrode supplied with the first driving power, a second electrode connected to a sixth switch node, and a gate electrode connected to a fifth switch node; a fifth capacitor having a first electrode supplied with the first driving power and a second electrode connected to the fifth switch node; and a sixth capacitor having a first electrode connected to the ground and a second electrode connected to the fifth switch node.

The second switch may include a (2_2)-th switch transistor having a first electrode connected to the fourth switch node, a second electrode connected to a seventh switch node, and a gate electrode connected to the sixth switch node; a seventh capacitor having a first electrode connected to the seventh switch node and a second electrode connected to the sixth switch node; and a fourth resistor with one end connected to the seventh switch node and another end connected to the sixth switch node.

The (2_1)-th switch transistor may be a P-type transistor and the (2_2)-th switch transistor is an N-type transistor.

The second switch may further include an eighth capacitor having a first electrode connected to the seventh switch node and a second electrode connected to the sixth switch node; and a fifth resistor with one end connected to the seventh switch node and another end connected to the sixth switch node.

When switching from the first mode to the second mode, the second enable signal may transition from a low level to a high level after a first time interval after the first enable signal transitions from the high level to the low level.

When switching from the first mode to the second mode, the third enable signal may transition from the low level to the high level after a second time interval after the second enable signal transitions to the high level, and the fourth enable signal may transition from the low level to the high level after a third time interval after the third enable signal transitions to the high level.

During the second time interval, a value of the second driving power may transition from the low level to a middle level.

After the third time interval, the value of the second driving power may transition from the middle level to the high level.

In the second mode, the (1_1)-th switch transistor and the (1_2)-th switch transistor may be turned on, and the (2_1)-th switch transistor and the (2_2)-th switch transistor may be turned off.

When switching from the second mode to the first mode, the fourth enable signal may transition from a high level to a low level after a fourth time interval after the third enable signal transitions from the high level to the low level.

When switching from the second mode to the first mode, the second enable signal may transition from the high level to the low level after a fifth time interval after the fourth enable signal transitions to the low level, and the first enable signal may transition from the low level to the high level after a sixth time interval after the second enable signal transitions to the low level.

In the first mode, the (1_1)-th switch transistor and the (1_2)-th switch transistor may be turned off, and the (2_1)-th switch transistor and the (2_2)-th switch transistor may be turned on.

### BRIEF DESCRIPTION OF THE DRAWINGS

FIG. 1 is a diagram illustrating a display device according to an embodiment of the present disclosure.

FIG. 2 is a diagram illustrating an embodiment of a pixel shown in FIG. 1.

FIG. 3 is a diagram illustrating a timing controller and a power generator according to an embodiment of the present disclosure.

FIG. 4 is a block diagram illustrating an embodiment of a DC-DC converter of FIG. 3.

FIG. 5 is a block diagram illustrating an embodiment when the DC-DC converter of FIG. 4 is driven in a first mode.

FIG. 6 is a block diagram illustrating an embodiment when the DC-DC converter of FIG. 4 is driven in a second mode.

FIG. 7 is a diagram illustrating a circuit configuration of a first switch unit and a second switch unit.

FIG. 8 is a diagram illustrating waveforms of first to fourth enable signals and second driving power.

FIG. 9 is a diagram schematically illustrating whether a (1_1)-th switch transistor, a (1_2)-th switch transistor, a (2_1)-th switch transistor, and a (2_2)-th switch transistor are driven according to driving modes.

FIG. 10 is a diagram illustrating operation processes of a first switch unit and a second switch unit when switching from a first mode to a second mode.

FIG. 11 is a diagram illustrating operation processes of a first switch unit and a second switch unit when switching from a second mode to a first mode.

FIG. 12 is a diagram illustrating a circuit configuration of a first switch unit and a second switch unit according to an embodiment of the present disclosure.

FIG. 13 is a block diagram illustrating an electronic device according to embodiments of the present disclosure.

FIG. 14 is a diagram illustrating an example in which the electronic device of FIG. 13 is implemented as a smartphone.

FIG. 15 is a diagram illustrating an example in which the electronic device of FIG. 13 is implemented as a tablet PC.

### DETAILED DESCRIPTION

Hereinafter, embodiments according to the present disclosure are described in detail with reference to the accompanying drawings. It should be noted that in the following description, only portions necessary for understanding an operation according to the present disclosure may be described, and descriptions of other portions may be omitted in order not to obscure the subject matter of the present disclosure. In addition, the present disclosure may be embodied in other forms without being limited to embodiments described herein. However, embodiments of the present disclosure are described in detail in order for those skilled in the art to be able to readily implement the technical spirit of the present disclosure.

Throughout the specification, in a case where a component is “connected” to another component, the components may be “directly connected” or the components may be “indirectly connected” with another element interposed therebetween. Terms used herein are for describing specific embodiments and are not intended to limit the present disclosure. Throughout the specification, in a case where a certain portion “includes” a certain component, the portion may further include another component without excluding another component unless otherwise stated. The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. “At least one of X, Y, and Z” and “at least one selected from a group consisting of X, Y, and Z” may be interpreted as X only, Y only, Z only, or any combination of two or more of X, Y, and Z (for example, XYZ, XYY, YZ, and ZZ). Here, “and/or” includes all combinations of one or more of corresponding configurations.

Here, terms such as “first”, “second”, (1_1)-th, (1_2)-th, (2_1)-th and (2_2)-th may be used to describe various components, but these components are not limited to these terms. These terms are used to distinguish one component from another component. Therefore, a first component may refer to a second component within a range without departing from the scope disclosed herein.

Spatially relative terms such as “under”, “on”, and the like may be used for descriptive purposes, thereby describing a relationship between one element or feature and another element(s) or feature(s) as shown in the drawings. Spatially relative terms are intended to include other directions in use, in operation, and/or in manufacturing, in addition to the direction depicted in the drawings. For example, when a device shown in the drawing is turned upside down, elements depicted as being positioned “under” other elements or features may be positioned in a direction “on” the other elements or features. Therefore, in an embodiment, the term “under” may include both directions of on and under. In addition, the device may face in other directions (for example, rotated 90 degrees or in other directions) and thus the spatially relative terms used herein may be interpreted according thereto.

In addition, embodiments of the disclosure may be described here with reference to schematic diagrams (and intermediate structures) of the present disclosure, so that changes in a shape as shown due to, for example, manufacturing technology and/or a tolerance may be expected. Therefore, embodiments disclosed herein may not be construed as being limited to shown specific shapes, and should be interpreted as including, for example, changes in shapes that occur as a result of manufacturing. As described herein, the shapes shown in the drawings may not show actual shapes of areas of a device, and embodiments are not limited thereto.

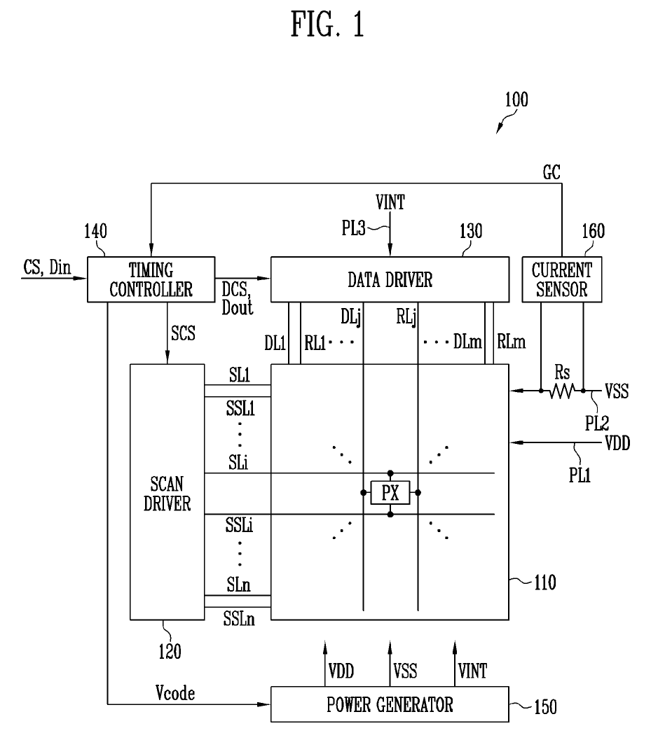

FIG. 1 is a diagram illustrating a display device 100 according to an embodiment of the present disclosure.

Referring to FIG. 1, the display device 100 according to an embodiment of the present disclosure may include a display panel 110, a scan driver 120, a data driver 130, a timing controller 140, a power generator 150, and a current sensor 160. The scan driver 120, the data driver 130, the timing controller 140, the power generator 150, and the current sensor 160 may constitute a driving device which drives the display panel 110.

The display panel 110 may display an image. The display panel 110 may include pixels PX connected to first scan lines SL1, …, SLi, …, SLn, second scan lines SSL1, …, SSLi, …, SSLn, data lines DL1, …, DLj, …, DLm, and readout lines RL1, …, RLj, …, RLm (where n and m each are natural numbers greater than or equal to 3, i is a natural number less than or equal to n and greater than or equal to 1, and j is a natural number less than or equal to m and greater than or equal to 1).

The pixel PX may be connected to one of the first scan lines SL1 to SLn and one of the data lines DL1 to DLm. In addition, the pixel PX may be connected to one of the second scan lines SSL1 to SSLn and one of the readout lines RL1 to RLm.

For example, the pixel PX located in an i-th row and a j-th column may be connected to the i-th first scan line SLi, the i-th second scan line SSLi, the j-th data line DLj, and the j-th readout line RLj. In addition, the pixel PX may be connected to a first power line PL1 to which a first driving power VDD is applied and a second power line PL2 to which a second driving power VSS is applied.

The first driving power VDD may be power which supplies a driving current to the pixel PX, and the second driving power VSS may be power which receives a driving current from the pixel PX. During an emission period of the pixel PX, the first driving power VDD may be set to a voltage higher than that of the second driving power VSS.

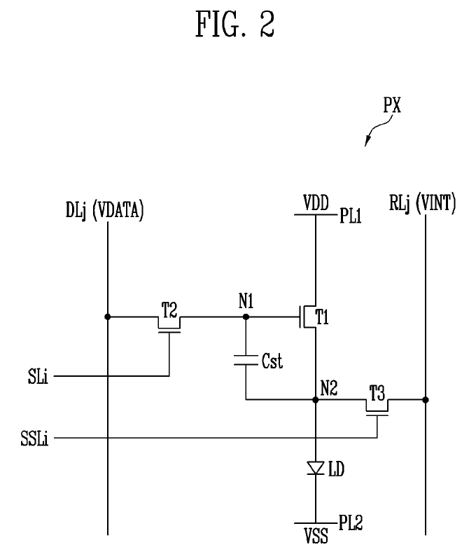

The pixel PX may be initialized by initialization power VINT provided through the readout line RLj in response to a second scan signal provided through the second scan line SSLi, and may be supplied with a data signal (or a data voltage) through the data line DLj in response to a first scan signal provided through the first scan line SLi. In response to the data signal, the pixel PX may generate light having luminance corresponding to the data signal while controlling the amount of current flowing from the first driving power VDD to the second driving power VSS via a light emitting device LD (see FIG. 2). The initialization power VINT may be set to a voltage lower than an operating point (or a threshold voltage) of the light emitting device LD.

The scan driver 120 may generate the first scan signal and the second scan signal based on a scan control signal SCS. The first scan signal may be sequentially supplied to the first scan lines SL1 to SLn, and the second scan signal may be sequentially supplied to the second scan lines SSL1 to SSLn.

The scan control signal SCS may include a start signal, a clock signal, and the like, and may be provided from the timing controller 140 to the scan driver 120. The scan driver 120 may be implemented as a shift register which sequentially generates and outputs the first scan signal in the form of a pulse by sequentially shifting the start signal in response to the clock signal. In addition, the scan driver 120 may generate and output the second scan signal in a manner similar to that of generating the first scan signal. The scan driver 120 may include a first scan driver for generating the first scan signal and a second scan driver for generating the second scan signal.

The scan driver 120 may be formed on the display panel 110 together with the pixel PX. However, embodiments of the present disclosure are not limited thereto, and for example, the scan driver 120 may be mounted on a circuit film and connected to the timing controller 140 via at least one circuit film and a printed circuit board.

The data driver 130 may generate the data signal (or the data voltage) based on output data Dout and a data control signal DCS provided from the timing controller 140, and provide the data signal to the display panel 110 (or the pixel PX) through the data lines DL1 to DLm. The data control signal DCS may include a data enable signal, a data clock signal, or the like. The data driver 130 may provide the initialization power VINT to the display panel 110 (or the pixel PX) through the readout lines RL1 to RLm.

In an embodiment, the data driver 130 may receive a sensing signal through the readout lines RL1 to RLm in a separate sensing period (e.g., in a sensing period allocated for sensing characteristic information of the pixel PX, such as a threshold voltage and/or mobility of a driving transistor included in the pixel PX). The sensing signal may be used to compensate for a characteristic (or a characteristic deviation) of the pixel PX in the data driver 130 and/or the timing controller 140.

In an embodiment, the readout lines RL1 to RLm may be connected to a separate sensing portion. The sensing portion may supply a voltage of the initialization power VINT to the display panel 110 or receive the sensing signal through the readout lines RL1 to RLm.

The power generator 150 may supply the first driving power VDD and the second driving power VSS to the display panel 110. The power generator 150 may supply the initialization power VINT to the data driver 130.

The power generator 150 may generate the first driving power VDD having a predetermined voltage in response to a voltage code Vcode supplied from the timing controller 140. The voltage of the first driving power VDD may be determined corresponding to the voltage code Vcode.

The power generator 150 may provide a driving voltage required for driving to at least one of the scan driver 120, the data driver 130, the timing controller 140, or the current sensor 160. The power generator 150 may be implemented as a power management integrated circuit (PMIC).

The first driving power VDD may be supplied to the display panel 110 through the first power line PL1. The second driving power VSS may be supplied to the display panel 110 through the second power line PL2. The initialization power VINT may be supplied to the data driver 130 through a third power line PL3. The first power line PL1 and the second power line PL2 may be connected in common to the pixels PX.

A sensing resistor Rs may be connected to the second power line PL2 connected in common to the pixels PX. For example, the sensing resistor Rs may be connected between the second power line PL2 and the display panel 110. The voltage (and the current) of the second driving power VSS may be supplied to the display panel 110 via the sensing resistor Rs. However, embodiments are not limited thereto. For example, the sensing resistor Rs may be connected to the first power line PL1 connected in common to the pixels PX. For example, the sensing resistor Rs may be connected between the first power line PL1 and the display panel 110.

The current sensor 160 may be electrically connected to opposite ends of the sensing resistor Rs. The current sensor 160 may sense a current flowing through the sensing resistor Rs to generate a global current value GC. The global current value GC generated (or sensed) by the current sensor 160 may be provided to the timing controller 140.

The global current value GC may correspond to a current supplied in common to the pixels PX via the second power line PL2. However, embodiments of the present disclosure are not limited thereto, and for example, the sensing resistor Rs may be connected to the first power line PL1 connected in common to the pixels PX to sense a current flowing through the first power line PL1. The current sensor 160 may generate the global current value GC from the sensing resistor Rs connected to the first power line PL1.

The timing controller 140 may receive input data Din and a control signal CS from an external device (for example, a graphics processor, an application processor, or the like), and generate the scan control signal SCS and the data control signal DCS based on the control signal CS.

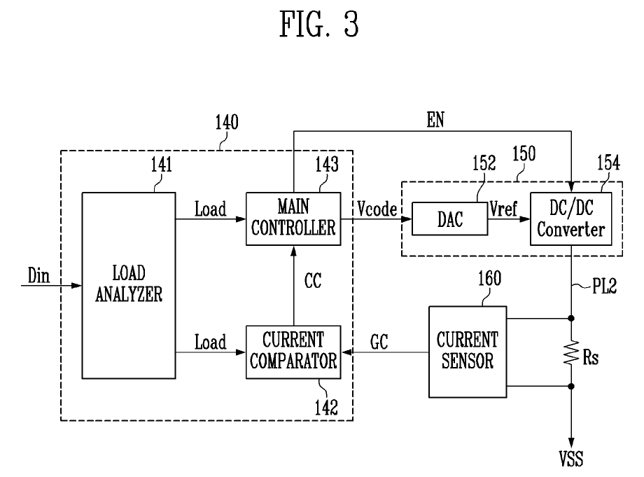

In an embodiment, the timing controller 140 may control the voltage of the second driving power VSS on a frame-by-frame basis in response to loads Load (see FIG. 3) of the pixels PX. For example, the timing controller 140 may generate the voltage code Vcode so that the second driving power VSS has a predetermined voltage value in response to the loads Load of the pixels PX.

FIG. 2 is a diagram illustrating an embodiment of the pixel PX shown in FIG. 1. In FIG. 2, the pixel PX located in the i-th row and the j-th column is shown as an example. The pixel PX shown in FIG. 2 is an embodiment, and the structure of the pixel PX of the present disclosure is not limited thereto. As an example, the pixel PX in the embodiment of the present disclosure may be selected from one of various circuits currently known.

Referring to FIG. 2, the pixel PX may be connected to the first scan line SLi, the second scan line SSLi, the data line DLj, and the readout line RLj.

The pixel PX may include the light emitting device LD, a first transistor T1 (or a driving transistor), a second transistor T2, a third transistor T3, and a storage capacitor Cst. Each of the first transistor T1, the second transistor T2, and the third transistor T3 may be a thin film transistor including an oxide semiconductor, but is not limited thereto, and for example, at least one or more of the first transistor T1, the second transistor T2, and the third transistor T3 may include a polysilicon semiconductor, or may be implemented with an N-type semiconductor or a P-type semiconductor.

A first electrode (or an anode electrode) of the light emitting device LD is connected to the first power line PL1 via a second node N2 and the first transistor T1, and a second electrode (or a cathode electrode) may be connected to the second power line PL2. The light emitting device LD may emit light having luminance corresponding to the driving current supplied from the first transistor T1.

The light emitting device LD may be selected as an organic light emitting diode. The light emitting device LD may also be selected as an inorganic light emitting diode, such as a micro light emitting diode (LED), or a quantum dot LED. In addition, the light emitting device LD may be a combination of an organic material and an inorganic material. Although FIG. 2 shows that the pixel PX includes a single light emitting device LD, in other embodiments, the pixel PX may include a plurality of light emitting devices, which may be connected in series, in parallel, or in series-parallel with each other.

A first electrode (e.g., a drain electrode) of the first transistor T1 may be connected to the first power line PL1 to which the first driving power VDD is applied, and a second electrode (e.g., a source electrode) may be connected to the second node N2. A gate electrode of the first transistor T1 may be connected to a first node N1. The first transistor T1 may control the amount of current flowing to the light emitting device LD in response to a voltage of the first node N1 (or a gate-source voltage across the gate electrode and the second electrode of the first transistor T1).

A first electrode of the second transistor T2 may be connected to the data line DLj, and a second electrode may be connected to the first node N1. A gate electrode of the second transistor T2 may be connected to the first scan line SLi. When the first scan signal is supplied to the first scan line SLi, the second transistor T2 may be turned on to transmit a data signal VDATA from the data line DLj to the first node N1.

The storage capacitor Cst may be formed or connected between the first node N1 and the second node N2. The storage capacitor Cst may store the voltage of the first node N1.

The third transistor T3 may be connected between the readout line RLj and the second node N2. A gate electrode of the third transistor T3 may be connected to the second scan line SSLi. When the second scan signal is supplied to the second scan line SSLi, the third transistor T3 may be turned on to transmit the voltage of the initialization power VINT from the readout line RLj to the second node N2.

When the second transistor T2 and the third transistor T3 are simultaneously turned on in response to the first scan signal and the second scan signal, a voltage difference between the data signal VDATA and the initialization power VINT is stored in the storage capacitor Cst. The first transistor T1 may control the amount of current flowing through the light emitting device LD in response to the voltage difference stored in the storage capacitor Cst.

Alternatively, when the third transistor T3 is turned on during the sensing period to connect the second node N2 and the readout line RLj, the sensing signal may be provided from the pixel PX to the readout line RLj.

FIG. 3 is a diagram illustrating the timing controller 140 and the power generator 150 according to an embodiment of the present disclosure.

Referring to FIG. 3, the power generator 150 according to an embodiment of the present disclosure may include a Digital-to-Analog Converter (DAC) 152 and a DC-DC converter 154.

The DAC 152 may generate a reference voltage Vref (or a feedback voltage) corresponding to the voltage code Vcode and supply the reference voltage Vref to the DC-DC converter 154. For example, the DAC 152 may supply the reference voltage Vref to the DC-DC converter 154 in response to the voltage code Vcode.

The DC-DC converter 154 may generate the second driving power VSS of a predetermined voltage based on the reference voltage Vref, and supply the second driving power VSS to the second power line PL2. The voltage of the second driving power VSS generated by the DC-DC converter 154 may be determined based on the voltage of reference power (i.e., the voltage code Vcode). However, the above-mentioned description is an example, and the first driving power VDD may also be described in the same way. Hereinafter, for convenience of description, the second driving power VSS will be mainly described.

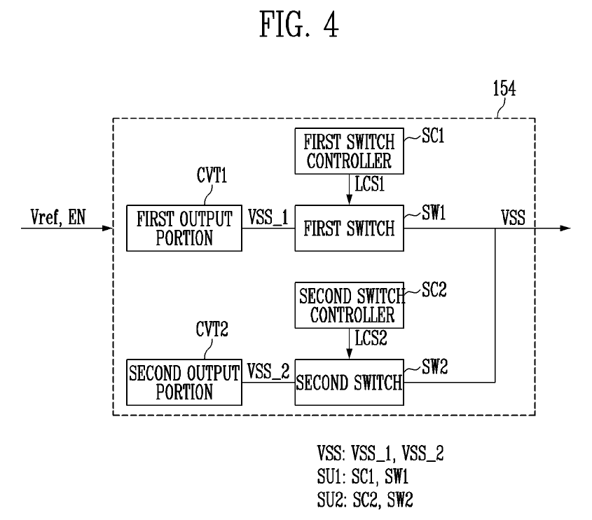

The timing controller 140 according to an embodiment of the present disclosure may include a load analyzer 141, a current comparator 142, and a main controller 143. The timing controller 140 may further include various other components, but only the components necessary for the description of the present disclosure are shown in FIG. 4.

The load analyzer 141 may calculate (or analyze) the load Load of the input data Din. For example, the load analyzer 141 may calculate the load Load of the input data Din corresponding to one frame. For example, the load analyzer 141 may calculate the load Load by averaging grayscales of the input data Din of one frame. As a method of calculating the load Load in the load analyzer 141, various currently known methods may be used.

The load Load may indicate a ratio of the pixels PX (see FIG. 2) which emit light to all pixels PX in the display panel 110. That is, when the display panel 110 emits light in full white (e.g., when all pixels PX in the display panel 110 emit light with luminance corresponding to white), the load Load may be set to 100%.

The main controller 143 may determine the voltage of the second driving power VSS in response to the load Load.

The current comparator 142 may receive the global current value GC from the current sensor 160, and may receive the load Load input from the load analyzer 141. The current comparator 142 receiving the load Load may extract a maximum current value which may flow in the display panel 110 in response to the load Load. The maximum current value may be read from memory provided in the timing controller 140.

The current comparator 142 may compare the maximum current value with the global current value GC, and supply a difference current value CC between the maximum current value and the global current value GC to the main controller 143 in response to the comparison result.

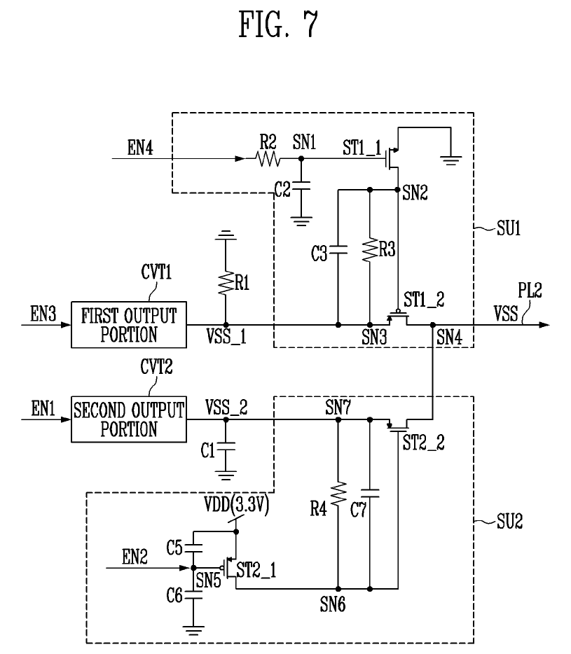

The main controller 143 may receive the load Load from the load analyzer 141. The main controller 143 may receive the difference current value CC from the current comparator 142. Accordingly, the main controller 143 compares the difference current value CC with a threshold current value corresponding to the load Load. The main controller 143 may be driven in a first mode when the difference current value CC is smaller than the threshold current value. Accordingly, the main controller 143 may supply a first enable signal EN1 (see FIG. 7) and a second enable signal EN2 (see FIG. 7) of an enable signal EN to the DC-DC converter 154 in the first mode.

In addition, the main controller 143 may be driven in a second mode when the difference current value CC is greater than the threshold current value. Accordingly, the main controller 143 may supply a third enable signal EN3 (see FIG. 7) and a fourth enable signal EN4 (see FIG. 7) of the enable signal EN to the DC-DC converter 154 in the second mode.

The main controller 143 may generate the voltage code Vcode and supply the voltage code Vcode to the power generator 150. The power generator 150 may generate the second driving power VSS in response to the voltage code Vcode and supply the second driving power VSS to the display panel 110.

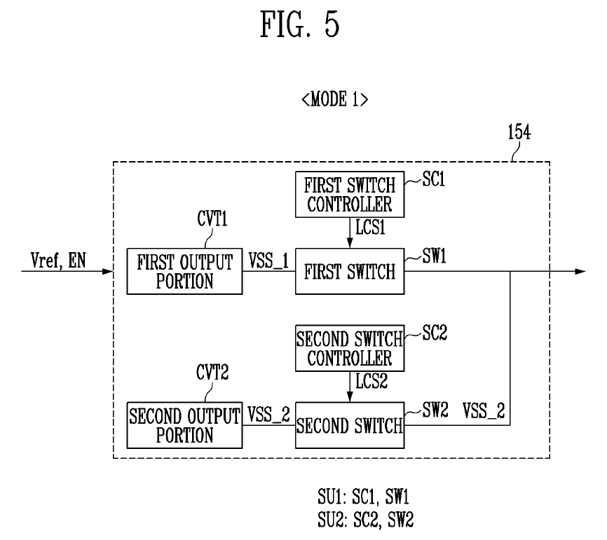

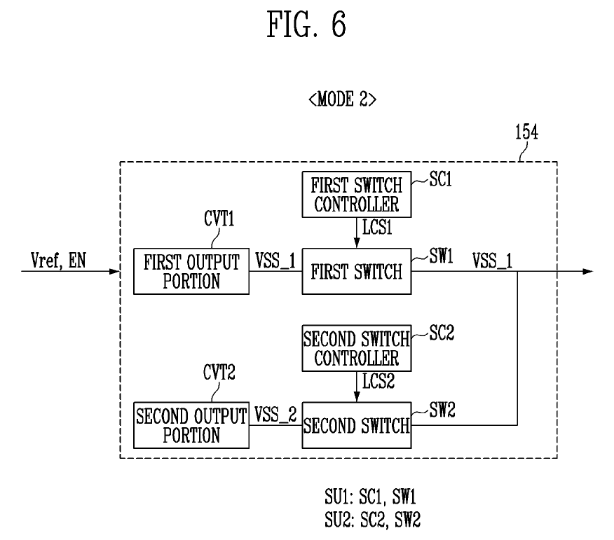

FIG. 4 is a block diagram illustrating an embodiment of the DC-DC converter 154 of FIG. 3. FIG. 5 is a block diagram illustrating an embodiment when the DC-DC converter 154 of FIG. 4 is driven in the first mode. FIG. 6 is a block diagram illustrating an embodiment when the DC-DC converter 154 of FIG. 4 is driven in the second mode.

Referring to FIGS. 4 to 6, the DC-DC converter 154 may include a first output portion CVT1, a first switch unit SU1, a second output portion CVT2, and a second switch unit SU2.

The DC-DC converter 154 may be supplied with the voltage of the reference power and the enable signal EN as described above, and components of the DC-DC converter 154 may be driven at a time according to the supplied enable signal EN.

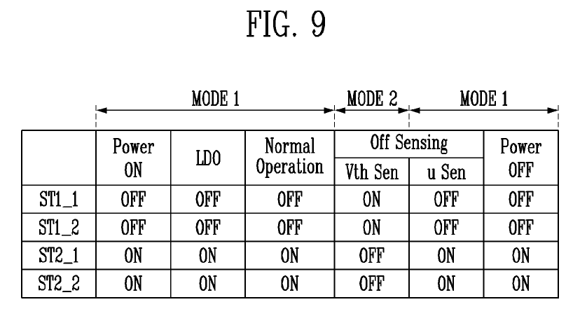

The first switch unit SU1 may include a first switch controller SC1 and a first switch SW1. The first switch unit SU1 may control whether to output (2_1)-th driving power VSS_1. For example, the first output portion CVT1 may supply the (2_1)-th driving power VSS_1 to the first switch SW1 according to the enable signal EN (e.g., third enable signal EN3). The first switch controller SC1 may determine whether to output the (2_1)-th driving power VSS_1 through the first switch SW1. For example, the first switch controller SC1 may supply a first switch control signal LCS1 to the first switch SW1. Accordingly, the first switch SW1 may or may not output the (2_1)-th driving power VSS_1 based on the first switch control signal LCS1. For example, referring to FIGS. 4 to 6, in the second mode (MODE 2 in FIG. 9), the first switch SW1 may output the (2_1)-th driving power VSS_1 while a (1_1)-th switch transistor ST1_1 (see FIG. 7) is turned on. On the other hand, in the first mode (MODE 1 in FIG. 9), the first switch SW1 may not output the (2_1)-th driving power VSS_1 while the (1_1)-th switch transistor ST1_1 (see FIG. 7) is turned off.

The second switch unit SU2 may include a second switch controller SC2 and a second switch SW2. The second switch unit SU2 may control whether to output (2_2)-th driving power VSS_2. For example, the second output portion CVT2 may supply the (2_2)-th driving power VSS_2 to the second switch SW2 according to the enable signal EN (e.g., first enable signal EN1). The second switch controller SC2 may determine whether to output the (2_2)-th driving power VSS_2 through the second switch SW2. For example, the second switch controller SC2 may supply a second switch control signal LCS2 to the second switch SW2. Accordingly, the second switch SW2 may or may not output the (2_2)-th driving power VSS_2 based on the second switch control signal LCS2. For example, referring to FIGS. 4 to 6, in the second mode, the second switch SW2 may not output the (2_2)-th driving power VSS_2 while a (2_1)-th switch transistor ST2_1 (see FIG. 7) is turned off. On the other hand, in the first mode, the second switch SW2 may output the (2_2)-th driving power VSS_2 while the (2_1)-th switch transistor ST2_1 (see FIG. 7) is turned on.

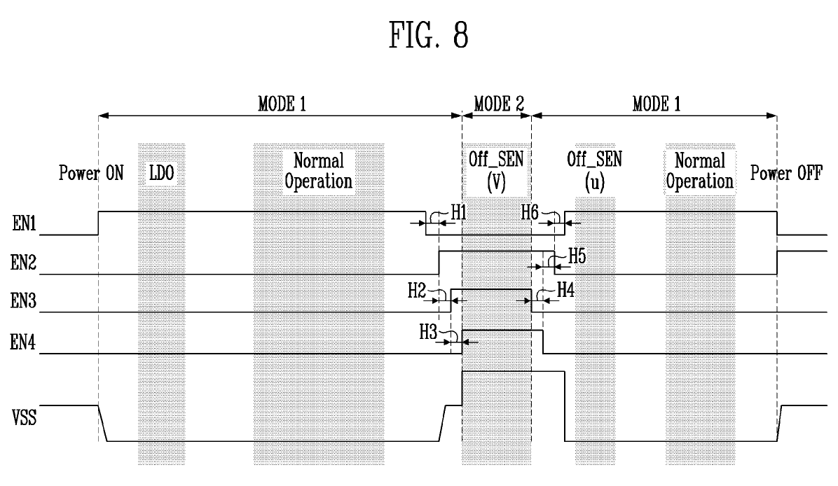

FIG. 7 is a diagram illustrating a circuit configuration of the first switch unit SU1 and the second switch unit SU2. FIG. 8 is a diagram illustrating waveforms of the first to fourth enable signals EN1 to EN4 and the second driving power VSS. FIG. 9 is a diagram schematically illustrating whether the (1_1)-th switch transistor ST1_1, a (1_2)-th switch transistor ST1_2, the (2_1)-th switch transistor ST2_1, and a (2_2)-th switch transistor ST2_2 are driven according to driving modes.

Referring to FIG. 7, the first switch unit SU1 may include a second resistor R2, a second capacitor C2, a third resistor R3, a third capacitor C3, the (1_1)-th switch transistor ST1_1, and the (1_2)-th switch transistor ST1_2.

One electrode of the (1_1)-th switch transistor ST1_1 may be in a grounded state. The other electrode of the (1_1)-th switch transistor ST1_1 may be connected to a gate electrode of the (1_2)-th switch transistor ST1_2. A gate electrode of the (1_1)-th switch transistor ST1_1 may be connected to a first node SN1.

One electrode of the second capacitor C2 may be connected to the first node SN1 to which the gate electrode of the (1_1)-th switch transistor ST1_1 and the second resistor R2 are connected. The other electrode of the second capacitor C2 may be in a grounded state. Accordingly, an RC delay effect may be generated in the gate electrode of the (1_1)-th switch transistor ST1_1. In other words, a slew rate of a voltage charged to the gate electrode of the (1_1)-th switch transistor ST1_1 may be reduced by the second capacitor C2 and the second resistor R2 included in the first switch unit SU1. Accordingly, the electric shock applied to the (1_1)-th switch transistor ST1_1 (or the first switch unit SU1) may be relatively weakened.

According to an embodiment, a capacitance value of the second capacitor C2 may be 2200 nF. A resistance value of the second resistor R2 may be 100 kohms. However, the values are not limited thereto.

The (1_1)-th switch transistor ST1_1 may be driven according to the fourth enable signal EN4 transmitted via the second resistor R2. For example, the gate electrode of the (1_1)-th switch transistor ST1_1 may receive the fourth enable signal EN4 and be turned on/off in response to the fourth enable signal EN4. Accordingly, the (1_1)-th switch transistor ST1_1 may control whether to drive the (1_2)-th switch transistor ST1_2. For example, when the (1_1)-th switch transistor ST1_1 is turned on, a predetermined signal may be applied to the gate electrode of the (1_2)-th switch transistor ST1_2. Accordingly, the (1_2)-th switch transistor ST1_2 may output the (2_1)-th driving power VSS_1 received from the first output portion CVT1.

One electrode of the (1_2)-th switch transistor ST1_2 may be connected to a third node SN3. The gate electrode of the (1_2)-th switch transistor ST1_2 may be connected to a second node SN2. The other electrode of the (1_2)-th switch transistor ST1_2 may be connected to the third node SN3. The (1_2)-th switch transistor ST1_2 may be connected in parallel with the third capacitor C3 and the third resistor R3. For example, one end of the third resistor R3 may be connected to the second node SN2, and the other end thereof may be connected to the third node SN3. In addition, one electrode of the third capacitor C3 may be connected to the second node SN2, and the other electrode may be connected to the third node SN3.

According to an embodiment, the (1_1)-th switch transistor ST1_1 may be an N-type transistor. Furthermore, the (1_2)-th switch transistor ST1_2 may be a P-type transistor. However, the descriptions of the switch transistors are illustrative and the switch transistors are not limited thereto.

The second switch unit SU2 may include a fourth resistor R4, a fifth capacitor C5, a sixth capacitor C6, a seventh capacitor C7, the (2_1)-th switch transistor ST2_1, and the (2_2)-th switch transistor ST2_2.

One electrode of the fifth capacitor C5 may be connected to the first driving power VDD, and the other electrode may be connected to a fifth node SN5. One electrode of the sixth capacitor C6 may be connected to the fifth node SN5, and the other electrode may be connected to ground.

One electrode of the (2_1)-th switch transistor ST2_1 may be connected to the first driving power VDD. A gate electrode of the (2_1)-th switch transistor ST2_1 may be connected to the fifth node SN5. The other electrode of the (2_1)-th switch transistor ST2_1 may be connected to a sixth node SN6.

The (2_1)-th switch transistor ST2_1 may be driven according to the second enable signal EN2. For example, the gate electrode of the (2_1)-th switch transistor ST2_1 may receive the second enable signal EN2 and be turned on/off in response to the second enable signal EN2. Accordingly, the (2_1)-th switch transistor ST2_1 may control whether to drive the (2_2)-th switch transistor ST2_2. For example, when the (2_1)-th switch transistor ST2_1 is turned on, a predetermined signal may be applied to a gate electrode of the (2_2)-th switch transistor ST2_2. Accordingly, the (2_2)-th switch transistor ST2_2 may output the (2_2)-th driving power VSS_2 received from the second output portion CVT2.

One electrode of the (2_2)-th switch transistor ST2_2 may be connected to a fourth node SN4. The gate electrode of the (2_2)-th switch transistor ST2_2 may be connected to the sixth node SN6. The other electrode of the (2_2)-th switch transistor ST2_2 may be connected to a seventh node SN7. The (2_2)-th switch transistor ST2_2 may be connected in parallel with a seventh capacitor C7 and the fourth resistor R4. For example, one end of the fourth resistor R4 may be connected to the seventh node SN7, and the other end thereof may be connected to a sixth node SN6. In addition, one electrode of the seventh capacitor C7 may be connected to the seventh node SN7, and the other electrode may be connected to the sixth node SN6.

According to an embodiment, the (2_1)-th switch transistor ST2_1 may be a P-type transistor. In addition, the (2_2)-th switch transistor ST2_2 may be an N-type transistor. However, the descriptions of the switch transistors are illustrative and the switch transistors are not limited thereto.

The first output portion CVT1 may receive the third enable signal EN3. Accordingly, the first output portion CVT1 may output the (2_1)-th driving power VSS_1 in response to the third enable signal EN3. An output end of the first output portion CVT1 may be connected to one end of a first resistor R1. The (2_1)-th driving power VSS_1 output from the first output portion CVT1 may be controlled by the first switch unit SU1. For example, in the first mode (MODE 1 in FIG. 8), the first switch unit SU1 may not output the (2_1)-th driving power VSS_1 to the second power line PL2. In addition, in the second mode (MODE 2 in FIG. 8), the first switch unit SU1 may output the (2_1)-th driving power VSS_1 to the second power line PL2.

The second output portion CVT2 may receive the first enable signal EN1. Accordingly, the second output portion CVT2 may output the (2_2)-th driving power VSS_2 in response to the first enable signal EN1. An output end of the second output portion CVT2 may be connected to one end of a first capacitor C1. The (2_2)-th driving power VSS_2 output from the second output portion CVT2 may be controlled by the second switch unit SU2. For example, in the first mode, the second switch unit SU2 may output the (2_2)-th driving power VSS_2 to the second power line PL2. In addition, in the second mode, the second switch unit SU2 may not output the (2_2)-th driving power VSS_2 to the second power line PL2.

According to an embodiment of the present disclosure, the (2_1)-th driving power VSS_1 may be a voltage having a positive value. In addition, the (2_2)-th driving power VSS_2 may be a voltage having a negative value. For example, the (2_1)-th driving power VSS_1 may be 6.7 V, and the (2_2)-th driving power VSS_2 may be −3 V. However, the descriptions of the driving power are illustrative and the driving power is not limited thereto.

Referring to FIG. 8, the power generator 150 (see FIG. 3) may be driven in the first mode or the second mode. The first mode may have a plurality of driving modes. For example, the power generator 150 may include a low dropout (“LDO”) regulator. LDO regulators may be used to reduce (or remove) noise included in input power (e.g., the second driving power VSS) to supply power at a stable voltage level. That is, the first mode may include an LDO mode for removing noise of the second driving power VSS.

In the LDO mode, the second driving power VSS may be at a low level. The first enable signal EN1 may be at a high level and the second enable signal EN2 may be at the low level. In addition, the third enable signal EN3 and the fourth enable signal EN4 may be at the low level.

After the LDO mode, the power generator 150 may be generally driven. Even at that point, the first enable signal EN1 may be at the high level and the second enable signal EN2 may be at the low level. In addition, the third enable signal EN3 and the fourth enable signal EN4 may be at the low level.

Thereafter, the power generator 150 may be driven in the second mode. According to an embodiment of the present disclosure, before the power generator 150 is driven in the second mode, the first enable signal EN1 may transition from the high level to the low level in advance at a predetermined time interval. For example, the first enable signal EN1 may first transition from the high level to the low level by an amount equal to the sum of a first time interval H1, a second time interval H2, and a third time interval H3 before the power generator 150 is driven in the second mode. Accordingly, the second output portion CVT2 may be turned off. In addition, the second enable signal EN2 may transition from the low level to the high level after the first time interval H1 from when the first enable signal EN1 transitions from the high level to the low level. Accordingly, the second switch unit SU2 may be turned off.

Further, before the power generator 150 is driven in the second mode, the third enable signal EN3 may transition from the low level to the high level. That is, the third enable signal EN3 may transition from the low level to the high level after the second time interval H2 from when the second enable signal EN2 transitions from the low level to the high level. At this time, the first output portion CVT1 may be driven, and the value of the second driving power VSS may transition from the low level to a middle level.

Further, the fourth enable signal EN4 may transition from the low level to the high level after the third time interval H3 from when the third enable signal EN3 transitions from the low level to the high level. Accordingly, the first switch unit SU1 may be turned on, and the value of the second driving power VSS may transition from the middle level to the high level. That is, the value of the second driving power VSS has a positive value, and the power generator 150 may be driven in the second mode.

Referring to FIGS. 7 to 9, when the power generator 150 is driven in the first mode (e.g., an LDO mode period, a normal operation period, and a u-sensing period), the (1_1)-th switch transistor ST1_1 and the (1_2)-th switch transistor ST1_2 may be in a turn-off state. On the other hand, the (2_1)-th switch transistor ST2_1 and the (2_2)-th switch transistor ST2_2 may be in a turn-on state in the first mode. The u-sensing period may be a period for sensing a slope of the current flowing through the first transistor T1 (see FIG. 2). Accordingly, the value of the second driving power VSS may be a negative value in the first mode.

According to an embodiment, the second mode (MODE 2 in FIG. 8) may include a Vth sensing period. The Vth sensing period may be a period for sensing a threshold voltage of the first transistor T1. That is, when sensing the threshold voltage of the first transistor T1, the (1_1)-th switch transistor ST1_1 and the (1_2)-th switch transistor ST1_2 may be in the turn-on state. On the other hand, the (2_1)-th switch transistor ST2_1 and the (2_2)-th switch transistor ST2_2 may be in the turn-off state. Accordingly, the value of the second driving power VSS may be converted from the negative value to a positive value.

The power generator 150 may be switched from the second mode to the first mode. At this time, the third enable signal EN3 may transition from the high level to the low level. Accordingly, the first output portion CVT1 may be turned off. The fourth enable signal EN4 may transition from the high level to the low level after a fourth time interval H4 from when the third enable signal EN3 transitions from the high level into the low level. Accordingly, the first switch unit SU1 may be turned off.

Thereafter, the second enable signal EN2 may transition from the high level to the low level after a fifth time interval H5 from when the fourth enable signal EN4 transitions from the high level to the low level. Accordingly, the second switch unit SU2 may be turned on. Thereafter, the first enable signal EN1 may transition from the low level to the high level after a sixth time interval H6 from when the second enable signal EN2 transitions from the high level to the low level. At this time, the second driving power VSS may transition from the high level to the low level. That is, the second driving power VSS has a negative value, and the power generator 150 may be driven in the first mode.

The first to sixth time intervals H1 to H6 may be the same time interval as each other. However, embodiments are not limited thereto. For example, the first time interval H1 and the second time interval H2 may be different time intervals.

According to an embodiment, the power generator 150 may not be driven. At this time, the first enable signal EN1 may transition from the low level to the high level, and the second enable signal EN2 may transition from the high level to the low level. In addition, the third enable signal EN3 and the fourth enable signal EN4 may maintain the low level.

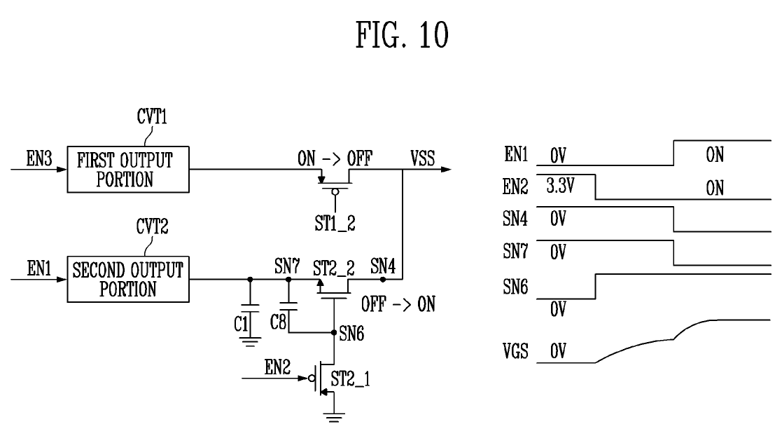

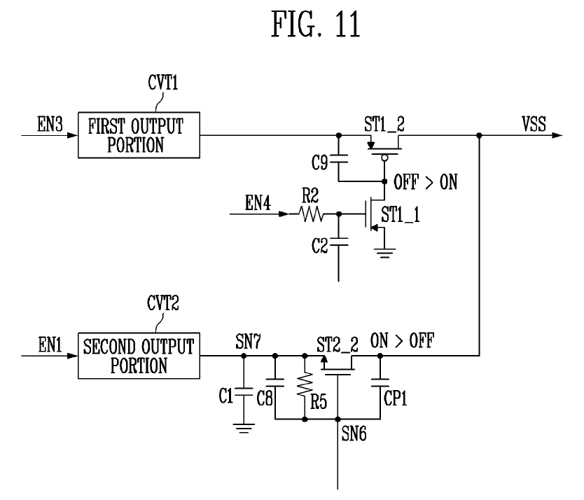

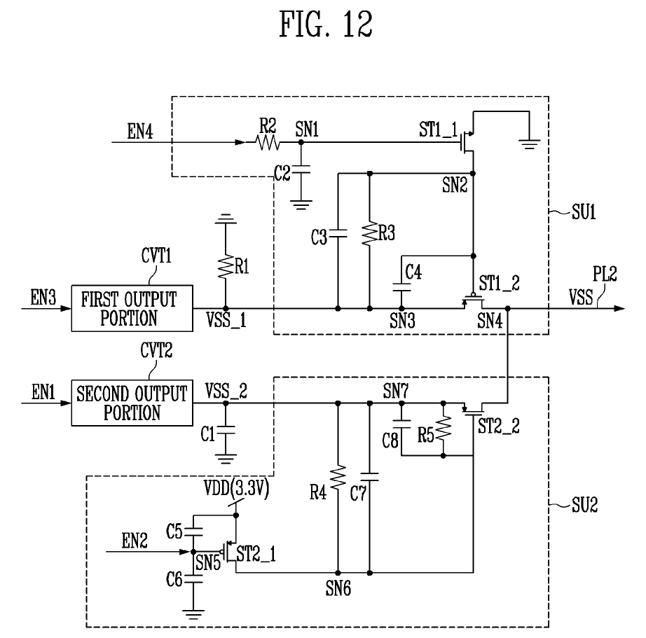

FIG. 10 is a diagram illustrating operation processes of the first switch unit SU1 and the second switch unit SU2 when switching from the first mode to the second mode. FIG. 11 is a diagram illustrating operation processes of the first switch unit SU1 and the second switch unit SU2 when switching from the second mode to the first mode. FIG. 12 is a diagram illustrating a circuit configuration of the first switch unit SU1 and the second switch unit SU2 according to an embodiment of the present disclosure.

Referring to FIGS. 10 to 12, the second switch unit SU2 according to an embodiment of the present disclosure may further include an eighth capacitor C8. One electrode of the eighth capacitor C8 may be connected to the seventh node SN7. The other electrode of the eighth capacitor C8 may be connected to the sixth node SN6. The first switch unit SU1 according to an embodiment of the present disclosure may further include a fourth capacitor C4. One electrode of the fourth capacitor C4 may be connected to the second node SN2. The other electrode of the fourth capacitor C4 may be connected to the third node SN3.

When switching from the second mode to the first mode, the (1_2)-th switch transistor ST1_2 may be turned off. That is, the first output portion CVT1 may turn off the (1_2)-th switch transistor ST1_2 in response to the third enable signal EN3. On the other hand, when switching from the second mode to the first mode, the (2_2)-th switch transistor ST2_2 may be turned on. For example, to turn on the (2_2)-th switch transistor ST2_2, the second output portion CVT2 may be driven and the second enable signal EN2 may be applied to the gate electrode of the (2_1)-th switch transistor ST2_1.

According to a comparative example, the first enable signal EN1 transitions from the low level to the high level, and then the second enable signal EN2 transitions from the high level to the low level, and the (2_1)-th switch transistor ST2_1 may be turned off. Accordingly, a voltage VGS of the gate electrode of the (2_2)-th switch transistor ST2_2 may be rapidly increased, and an electrical shock may be applied to the (2_2)-th switch transistor ST2_2.

On the other hand, according to an embodiment of the present disclosure, the second enable signal EN2 transitions from the high level to the low level first, so that a voltage of the sixth node SN6 may transition from the low level to the high level. At this time, the first enable signal EN1 may maintain the low level, and voltages of the fourth node SN4 and the seventh node SN7 may maintain the high level. Accordingly, the voltage VGS of the gate electrode of the (2_2)-th switch transistor ST2_2 (or the voltage difference between the sixth node SN6 and the seventh node SN7) may be relatively small compared to the comparative example. Thereafter, the first enable signal EN1 may transition from the low level to the high level, and the voltages of the fourth node SN4 and the seventh node SN7 may transition from the high level to the low level. Accordingly, the voltage VGS of the gate electrode of the (2_2)-th switch transistor ST2_2 may rise relatively slowly, and the risk of an electrical shock being applied to the (2_2)-th switch transistor ST2_2, or the second switch unit SU2, may be prevented or mitigated.

Referring to FIGS. 10 to 12, the second switch unit SU2 according to an embodiment of the present disclosure may further include a fifth resistor R5. One end of the fifth resistor R5 may be connected to the sixth node SN6. The other end of the fifth resistor R5 may be connected to the seventh node SN7. According to an embodiment, a resistance value of the fifth resistor R5 may be, but is not limited to, 10 kohms.

The second switch unit SU2 may further include a parasitic capacitor CP1. For example, the parasitic capacitor CP1 may be connected to one electrode of the (2_2)-th switch transistor ST2_2 and the sixth node SN6.

According to a comparative example, when there is no fifth resistor R5, a predetermined voltage may flow into the gate electrode of the (2_2)-th switch transistor ST2_2 by the parasitic capacitor CP1. On the other hand, the fifth resistor R5 may enable the voltage applied to the gate electrode of the (2_2)-th switch transistor ST2_2 to be maintained at 0 V when the (2_2)-th switch transistor ST2_2 is turned off, and the reliability of the driving of the second switch unit SU2 may be improved.

When switching from the first mode to the second mode, the (1_2)-th switch transistor ST1_2 may be turned on. That is, the first output portion CVT1 may turn on the (1_2)-th switch transistor ST1_2 in response to the third enable signal EN3. On the other hand, when switching from the first mode to the second mode, the (2_2)-th switch transistor ST2_2 may be turned off. For example, the second output portion CVT2 may turn off the (2_2)-th switch transistor ST2_2 in response to the first enable signal EN1.

According to a comparative example, the first enable signal EN1 may be supplied to the second output portion CVT2, after which the second enable signal EN2 may be applied to the gate electrode of the (2_1)-th switch transistor ST2_1. Accordingly, the voltage VGS of the gate electrode of the (2_2)-th switch transistor ST2_2 may be rapidly increased, and an electrical shock may be applied to the (2_2)-th switch transistor ST2_2.

On the other hand, according to an embodiment of the present disclosure, the second enable signal EN2 may be applied to the gate electrode of the (2_1)-th switch transistor ST2_1. Accordingly, the voltage of the sixth node SN6 may transition from the low level to the high level. At this time, the first enable signal EN1 might not be supplied to the second output portion CVT2 yet. Accordingly, the voltages of the fourth node SN4 and the seventh node SN7 may be maintained at the high level. Accordingly, the voltage VGS of the gate electrode of the (2_2)-th switch transistor ST2_2 (or the voltage difference between the sixth node SN6 and the seventh node SN7) may be relatively small compared to the comparative example. Then, the first enable signal EN1 is supplied to the second output portion CVT2, and the voltages of the fourth node SN4 and the seventh node SN7 may transition from the high level to the low level. Accordingly, the voltage VGS of the gate electrode of the (2_2)-th switch transistor ST2_2 may be relatively gradually increased, and the risk of an electrical shock being applied to the (2_2)-th switch transistor ST2_2, may be prevented or mitigated.

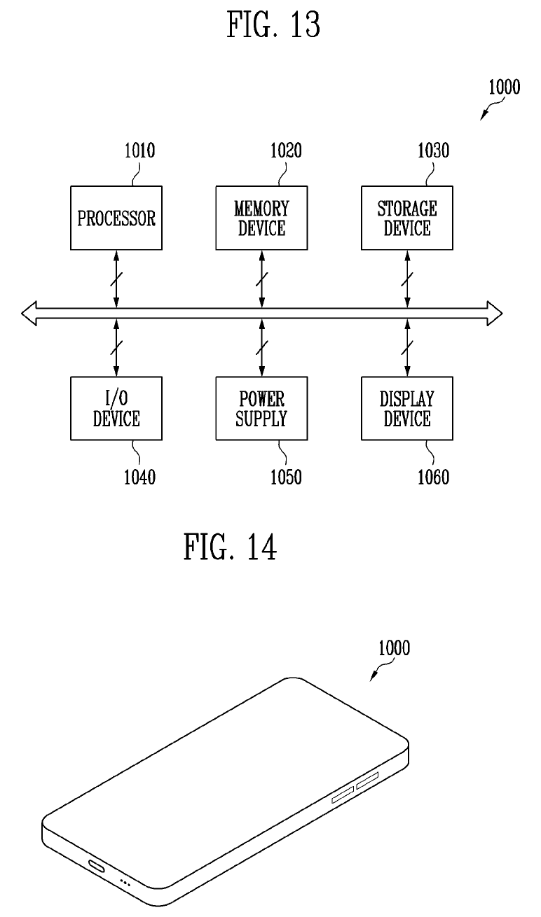

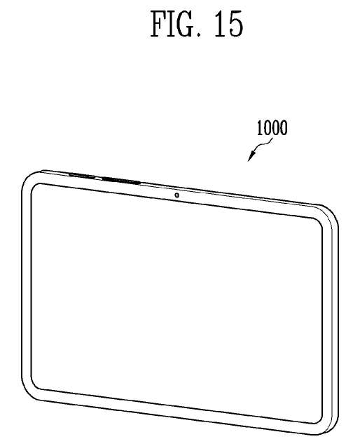

FIG. 13 is a block diagram illustrating an electronic device 1000 according to embodiments of the present disclosure, FIG. 14 is a diagram illustrating an example in which the electronic device 1000 of FIG. 13 is implemented as a smartphone, and FIG. 15 is a diagram illustrating an example in which the electronic device 1000 of FIG. 13 is implemented as a tablet PC.

Referring to FIGS. 13 to 15, the electronic device 1000 may include a processor 1010, a memory device 1020, a storage device 1030, an input/output device 1040, a power supply 1050, and a display device 1060. The display device 1060 may be the display device of FIG. 1. In addition, the electronic device 1000 may further include various ports which may communicate with a video card, a sound card, a memory card, a Universal Serial Bus (USB) device, or the like, or communicate with other systems. In an embodiment, as shown in FIG. 14, the electronic device 1000 may be implemented as a smartphone. In an embodiment, as shown in FIG. 15, the electronic device 1000 may be implemented as a tablet PC. However, these embodiments are provided as examples, and the electronic device 1000 is not limited thereto. For example, the electronic device 1000 may be implemented as a mobile phone, a video phone, a smart pad, a smart watch, a vehicle navigation system, a computer monitor, a notebook, a head-mounted display device, or the like.

The processor 1010 may perform certain calculations or tasks. According to an embodiment, the processor 1010 may be a microprocessor, a central processing unit, an application processor, or the like. The processor 1010 may be connected to other components via an address bus, a control bus, a data bus, and the like. According to an embodiment, the processor 1010 may also be connected to an extension bus, such as a Peripheral Component Interconnect (PCI) bus.

The memory device 1020 may store data necessary for the operation of the electronic device 1000. For example, the memory device 1020 may include a non-volatile memory device such as an Erasable Programmable Read-Only Memory (EPROM) device, an Electrically Erasable Programmable Read-Only Memory (EEPROM) device, a flash memory device, a Phase Change Random Access Memory (PRAM) device, a Resistance Random Access Memory (RRAM) device, a Nano Floating Gate Memory (NFGM) device, a Polymer Random Access Memory (PoRAM) device, a Magnetic Random Access Memory (MRAM) device, or a Ferroelectric Random Access Memory (FRAM) device, and/or a volatile memory device such as a Dynamic Random Access Memory (DRAM) device, a Static Random Access Memory (SRAM) device, or a mobile DRAM device.

The storage device 1030 may include a Solid-State Drive (SSD), a Hard Disk Drive (HDD), a CD-ROM, and the like.

The input/output device 1040 may include input means such as a keyboard, a keypad, a touchpad, a touchscreen, or a mouse, and output means such as a speaker, or a printer. According to an embodiment, the display device 1060 may be included in the input/output device 1040.

The power supply 1050 may supply power necessary for the operation of the electronic device 1000. For example, the power supply 1050 may be a power management integrated circuit (PMIC).

The display device 1060 may display an image corresponding to visual information of the electronic device 1000. The display device 1060 may be, but is not limited to, an organic light emitting display device or a quantum dot light emitting display device. The display device 1060 may be connected to other components via the above-mentioned buses or other communication links. The display device 1060 of FIG. 13 may be described in the same manner as the display device 100 of FIG. 1.

Although specific embodiments and applications have been described herein, other embodiments and variations may be derived from the above descriptions. Accordingly, the spirit of the present disclosure is not limited to these embodiments, but extends to claims set forth below, various obvious modifications, and equivalents.

According to an electronic device of the present disclosure, a risk of electrical damage to the electronic device (or a circuit inside the electronic device) may be prevented or mitigated by controlling a value of second driving power according to driving modes of the electronic device.

However, the effects according to embodiments of the present disclosure are not limited to the effects described above, and wider variety of effects are included herein.

What is claimed is:

1. An electronic device comprising:
a processor, which provides input image data to a display device; and
the display device, which displays an image based on the input image data,
wherein the display device comprises:
a display panel including pixels connected to a first power line, a second power line, scan lines, and data lines;
a power generator, which supplies first driving power to the first power line and second driving power to the second power line; and
a timing controller, which generates first to fourth enable signals for controlling the second driving power according to a driving mode,
wherein the second driving power includes (2_1)-th driving power having a positive value and (2_2)-th driving power having a negative value, and
wherein the power generator comprises:
a second switch unit, which outputs the (2_2)-th driving power to the second power line in a first mode; and
a first switch unit, which outputs the (2_1)-th driving power to the second power line in a second mode different from the first mode.

2. The electronic device according to claim 1, wherein the power generator further comprises:
a first output portion, which outputs the (2_1)-th driving power based on the third enable signal; and
a second output portion, which outputs the (2_2)-th driving power based on the first enable signal.

3. The electronic device according to claim 2, wherein the first switch unit comprises:
a first switch, which receives the (2_1)-th driving power from the first output portion; and
a first switch controller, which turns off the first switch in the first mode and turns on the first switch in the second mode, in response to the fourth enable signal.

4. The electronic device according to claim 3, wherein the second switch unit comprises:
a second switch, which receives the (2_2)-th driving power from the second output portion; and
a second switch controller, which turns on the second switch in the first mode and turns off the second switch in the second mode, in response to the second enable signal.

5. The electronic device according to claim 4, wherein the first switch controller comprises:
a (1_1)-th switch transistor having a first electrode connected to ground, a second electrode connected to a second switch node, and a gate electrode connected to a first switch node;
a second capacitor having a first electrode connected to the ground and a second electrode connected to the first switch node; and
a second resistor with one end connected to the first switch node and another end, to which the fourth enable signal is supplied.

6. The electronic device according to claim 5, wherein the first switch comprises:
a (1_2)-th switch transistor having a first electrode connected to a third switch node, a second electrode connected to a fourth switch node, and a gate electrode connected to the second switch node;
a third capacitor having a first electrode connected to the second switch node and a second electrode connected to the third switch node; and
a third resistor with one end connected to the second switch node and another end connected to the third switch node.

7. The electronic device according to claim 6, wherein the (1_1)-th switch transistor is an N-type transistor and the (1_2)-th switch transistor is a P-type transistor.

8. The electronic device according to claim 7, wherein the first switch further comprises a fourth capacitor having a first electrode connected to the second switch node and a second electrode connected to the third switch node.

9. The electronic device according to claim 6, wherein the second switch controller comprises:
a (2_1)-th switch transistor having a first electrode, to which the first driving power is supplied, a second electrode connected to a sixth switch node, and a gate electrode connected to a fifth switch node;
a fifth capacitor having a first electrode, to which the first driving power is supplied, and a second electrode connected to the fifth switch node; and
a sixth capacitor having a first electrode connected to the ground and a second electrode connected to the fifth switch node.

10. The electronic device according to claim 9, wherein the second switch comprises:
a (2_2)-th switch transistor having a first electrode connected to the fourth switch node, a second electrode connected to a seventh switch node, and a gate electrode connected to the sixth switch node;
a seventh capacitor having a first electrode connected to the seventh switch node and a second electrode connected to the sixth switch node; and
a fourth resistor with one end connected to the seventh switch node and another end connected to the sixth switch node.

11. The electronic device according to claim 10, wherein the (2_1)-th switch transistor is a P-type transistor and the (2_2)-th switch transistor is an N-type transistor.

12. The electronic device according to claim 11, wherein the second switch further comprises:
an eighth capacitor having a first electrode connected to the seventh switch node and a second electrode connected to the sixth switch node; and
a fifth resistor with one end connected to the seventh switch node and another end connected to the sixth switch node.

13. The electronic device according to claim 11, wherein when switching from the first mode to the second mode, the second enable signal transitions from a low level to a high level after a first time interval after the first enable signal transitions from the high level to the low level.

14. The electronic device according to claim 13, wherein when switching from the first mode to the second mode,
the third enable signal transitions from the low level to the high level after a second time interval after the second enable signal transitions to the high level, and
the fourth enable signal transitions from the low level to the high level after a third time interval after the third enable signal transitions to the high level.

15. The electronic device according to claim 14, wherein, during the second time interval, a value of the second driving power transitions from the low level to a middle level.

16. The electronic device according to claim 15, wherein, after the third time interval, the value of the second driving power transitions from the middle level to the high level.

17. The electronic device according to claim 14, wherein, in the second mode, the (1_1)-th switch transistor and the (1_2)-th switch transistor are turned on, and the (2_1)-th switch transistor and the (2_2)-th switch transistor are turned off.

18. The electronic device according to claim 11, wherein when switching from the second mode to the first mode, the fourth enable signal transitions from a high level to a low level after a fourth time interval after the third enable signal transitions from the high level to the low level.

19. The electronic device according to claim 18, wherein when switching from the second mode to the first mode,
the second enable signal transitions from the high level to the low level after a fifth time interval after the fourth enable signal transitions to the low level, and
the first enable signal transitions from the low level to the high level after a sixth time interval after the second enable signal transitions to the low level.

20. The electronic device according to claim 19, wherein in the first mode, the (1_1)-th switch transistor and the (1_2)-th switch transistor are turned off, and the (2_1)-th switch transistor and the (2_2)-th switch transistor are turned on.
